(19) United States
(12) Patent Application Publication
(10) Pub. No.: US 2025/0013080 A1
(43) Pub. Date: Jan. 9, 2025

(54) CROSSTALK-CORRECTED THERMO-OPTIC PHASE SHIFTER

(71) Applicant: California Institute of Technology, Pasadena, CA (US)

(72) Inventors: Baris Volkan Gurses, Pasadena, CA (US); Seyed Ali Hajimiri, La Canada, CA (US)

(21) Appl. No.: 18/665,480

(22) Filed: May 15, 2024

Related U.S. Application Data
(60) Provisional application No. 63/466,382, filed on May 15, 2023.

(51) Int. Cl. G02F 1/01

(52) U.S. Cl. CPC G02F 1/0121; G02F 1/011; G02F 1/0147; G02F 2203/50

(57) ABSTRACT

A method of correcting for crosstalk in thermo-optics phase shifters (TOPS) integrated on a substrate, includes, in part, determining a first value representative of an amount of electrical power applied to a heater associated with a first TOPS causing a known phase shift in an optical signal passing through the first TOPS' associated waveguide; determining a second value representative of a time constant of the first TOPS; determining a third value representative of an amount of electrical power applied to a heater associated with a second TOPS causing a known phase shift in an optical signal passing through the waveguide associated with the first TOPS; determining a multitude of thermal couplings between a multitude of heaters, waveguides and positions in the substrate using one or more of the first, second and third values; and making a correction associated with the crosstalk in accordance with the thermal couplings.

### RELATED APPLICATION

The present application claims benefit under 35 USC 119(e) of U.S. Patent Application No. 63/466,382, filed May 15, 2023, the content of which is incorporated herein by reference in its entirety.

### TECHNICAL FIELD

The present application relates to opto-electronic systems and photonic integrated circuits, and more particularly to thermo-optic phase shifters.

### BACKGROUND

Integrated photonics enable the integration of numerous bulk optic components such as lenses, modulators, and fiber-optics on a thin substrate to realize millimeter-scale, energy-efficient optical systems with improved manufacturability and cost. The advent of large-scale photonic integrated circuits, largely driven by silicon photonics, has enabled high-performance systems driving practical applications in sensing, communications, and computing. Silicon photonics leverages the high refractive index of silicon to enable the realization of optical waveguides with tight mode confinement. This, in turn, has enabled the integration of compact nanophotonic structures on chip and at a high volume. Combined with its CMOS compatibility, silicon photonics has enabled the largest scale photonic integrated circuits with tens of thousands of components realized on a single chip.

Large-scale photonic integrated circuits ubiquitously utilize phase shifters for modulation, tuning, calibration of systematic phase errors, and correction of random phases along the signal path. As the circuits scale, a larger number of phase shifters are often required for precise signal manipulation. Thermo-optic phase shifters (TOPS) are used in high-density silicon photonic integrated circuits due to their relatively low optical loss and small form factor. However, high-density TOPS arrays suffer from thermal crosstalk.

In high-density integration of TOPS, unless photonics and electronics are both monolithically integrated, electrical connections required to drive each phase shifter in a direct addressing scheme can pose scaling challenges. Furthermore, if each phase shifter requires its own driver, the complexity of the control electronics and their power consumption scale rapidly, thus becoming a limiting factor for scalability.

### SUMMARY

A method of correcting for crosstalk amongst a multitude of thermo-optics phase shifters (TOPS) integrated on a substrate (each TOPS includes, in part, a waveguide and an associated heater), in accordance with one embodiment of the present disclosure includes, in part, determining a first value representative of an amount of electrical power applied to a heater associated with a first TOPS causing a 180° phase shift in an optical signal passing through the TOP's associated waveguide; determining a second value representative of a time constant of the first TOPS; determining a third value representative of an amount of electrical power applied to a heater associated with a second TOPS causing a 180° phase shift in an optical signal passing through the waveguide associated with the first TOPS; determining a multitude of thermal couplings between the plurality of heaters, the plurality of waveguides and a plurality of positions in the substrate using one or more of the first, second and third values; and making, by a processor, a first correction associated with the crosstalk in accordance with the determined multitude of thermal couplings.

In one embodiment, the one or more of the first, second and third values are determined from measurements made a on a test structure. In one embodiment, the one or more of the first, second and third values are determined from computer simulations.

In one embodiment, the method further includes, in part, generating, in accordance with the multitude of thermal couplings and in the absence of cross talk, a first set of data representative of optical power output of a first one of the waveguides as a function of power applied to a heater associated with the first one of the waveguides.

In one embodiment, the method further includes, in part, generating, in accordance with the multitude of thermal couplings and in the presence of cross talk, a second set of data representative of output optical power output of the first one of the waveguides as a function of the power applied to the heater associated with the first one of the waveguides.

In one embodiment, the method further includes, in part, causing a variance between the first set of data and the second set of data to be less than a threshold value by changing one or more of a heat applied to the first one of the waveguides, a voltage applied to a first diode associated with the first one of waveguides, or a frequency the voltage applied to the first diode.

In one embodiment, the first and second TOPS are adjacent (neighboring) TOPS. In one embodiment, the multitude of TOPS are disposed along a multitude of rows and a multitude of columns. In one embodiment, the multitude of rows are folded. In one embodiment, a multitude of Mach-Zehnder interferometers and photodetectors associated with the TOPS are also integrated on the substrate. In one embodiment, the first and second set of data are generated using one or more Mach-Zehnder interferometers associated with at least the first TOPS.

A photonics system includes, in part: a multitude of TOPS each TOPS comprising a waveguide and an associated heater; a memory storing instructions; and a processor, coupled with the memory and to execute the instructions, the instructions when executed causing the processor to: determine a first value representative of an amount of electrical power applied to a heater associated with a first TOPS causing a 180° phase shift in an optical signal passing through the TOP's associated waveguide; determine a second value representative of a time constant of the TOPS; determine a third value representative of an amount of electrical power applied to a heater associated with a second TOPS causing a 180° phase shift in an optical signal passing through the waveguide associated with the first TOPS; determine a plurality of thermal couplings between the plurality of heaters, the plurality of waveguides and a plurality of positions in the substrate using one or more of the first, second and third values; and making a correction associated with the crosstalk in accordance with the determined plurality of thermal couplings.

In one embodiment, the one or more of the first, second and third values are determined from computer simulations. In one embodiment, the instructions further cause the processor to generate, in accordance with the plurality of thermal couplings and in the absence of crosstalk, a first set of data representative of optical power output of a first one of the waveguides as a function of power applied to a heater associated with the first one of the waveguides.

In one embodiment, the instructions further cause the processor to generate, in accordance with the plurality of thermal couplings and in the presence of crosstalk, a second set of data representative of optical power output of the first one of the waveguides as a function of power applied to the heater associated with the first one of the waveguides.

In one embodiment, the instructions further cause the processor to cause a variance between the first set of data and the second set of data to be less than a threshold value by changing one or more of a heat applied to the first one of the waveguides, a voltage applied to a first diode associated with the first one of waveguides, or a frequency the voltage applied to the first diode.

In one embodiment of the photonics system, the first and second TOPS are adjacent TOPS. In one embodiment of the photonics system, the plurality of TOPS are disposed along a plurality of rows and a plurality of columns. In one embodiment of the photonics system, the plurality of rows are folded.

In one embodiment, the photonics system further comprising a plurality of Mach-Zehnder Interferometers and a photodetectors associated with the TOPS. In one embodiment, an output of each Mach-Zehnder Interferometer is delivered to different one of the photodetectors. In one embodiment, at least one of the plurality of Mach-Zehnder Interferometers is used to generate the first and second set of data.

A photonic integrated circuit, in accordance with one embodiment of the present disclosure, includes, in part, a plurality of thermos-optic phase shifters arranged along a plurality of columns and a plurality of rows, wherein the plurality of rows are folded; a plurality of Mach-Zehnder interferometers associated with the plurality of thermos-optic phase shifters; and a plurality of photodiodes associated with the plurality of thermos-optic phase shifters.

In one embodiment, the plurality of photodiodes are configured to receive time-multiplexed modulated voltage waveforms. In one embodiment, the modulated voltage waveforms are selected from pulse-amplitude-modulated waveforms and pulse-width modulated waveforms. In one embodiment, a signal representative of an output of a first one the Mach-Zehnder interferometers is fed back to a thermo-optic phase shifter associated with the first one of the Mach-Zehnder interferometers. In one embodiment, a signal associated with at least one of the time-multiplexed modulated voltage waveforms includes pre-emphasis.

### BRIEF DESCRIPTION OF THE DRAWINGS

FIG. 1A is a simplified perspective and cross-sectional view of a portion of an array TOPS, in accordance with one embodiment of the present disclosure.

FIG. 1B is an expanded view of the cross-section of a region of the TOPS array of FIG. 1A, in accordance with one embodiment of the present disclosure.

FIG. 2 shows the direction of the heat flow from a heating element of a TOPS to other structures of the TOPS as well as to the environment, in accordance with one embodiment of the present disclosure.

FIG. 3 is a schematic diagram of a row and a number of columns 1-4 of a TOPS array, in accordance with one embodiment of the present disclosure.

FIGS. 4A shows exemplary pulse amplitude modulated voltages applied to a number of TOPS of an array, in accordance with one embodiment of the present disclosure.

FIGS. 4B shows exemplary pulse width modulated voltages applied to a number of TOPS of an array, in accordance with one embodiment of the present disclosure.

FIG. 5 is a micrograph of an array of 288 TOPS arranged along 32 rows and 9 columns, in accordance with one embodiment of the present disclosure.

FIGS. 6 is a schematic diagram of a TOPS array shown as including, in part, a multitude of waveguides, a light splitter, and photo-diodes, in accordance with one embodiment of the present disclosure.

FIG. 7 shows an array of TOPs folded in the direction of rows, in accordance with one exemplary embodiment of the present disclosure.

FIG. 8A shows a plot of the optical power supplied by an MZI of an associated waveguide as a function of the power applied to the resistor of the associated waveguide, in accordance with one exemplary embodiment of the present disclosure.

FIG. 8B shows a plot of the optical power supplied by an MZI of an associated waveguide as a function of the frequency, in accordance with one exemplary embodiment of the present disclosure.

FIG. 8C shows a plot of the optical power supplied by an MZI of an associated waveguide generated in response to a power applied to a neighboring TOPS, in accordance with one exemplary embodiment of the present disclosure.

FIG. 9A shows a multitude of simulated plots respectively associated with having no crosstalk, crosstalk, and corrected crosstalk for a TOPS, in accordance with one embodiment of the present disclosure.

FIG. 9B shows a multitude of plots respectively associated with having no crosstalk, crosstalk, and corrected crosstalk as measured on a TOPS after making correction identified by the adjustments made in FIG. 9A, in accordance with one embodiment of the present disclosure.

FIG. 10 is a schematic diagram of an exemplary computer system in which embodiments of the present disclosure may operate.

### DETAILED DESCRIPTION

In accordance with embodiments of the present disclosure, an array of Thermo-optic phase shifters (TOPS), disposed along a multitude of rows and columns of the array, compensates for thermal crosstalk between the phase shifters. Moreover, in accordance with embodiments of the present disclosure, the number of electrical connections scales as the square root (i.e., VN) of the number of phase shifters N, in contrast to conventional systems in which the number of electrical connections scales as the number N of phase shifters.

As described further below, in accordance with embodiments of the present disclosure, each phase shifter is disposed at an intersection (node) of a column and a row of the array and in series with an associated diode. The diode operates as a switch to enable a current to flow in order to modulate the diode's associated phase shifter. Accordingly, a selected column determines the diode which will be forward biased, whereas a selected row determines the amplitude of the electrical signal through the diode.

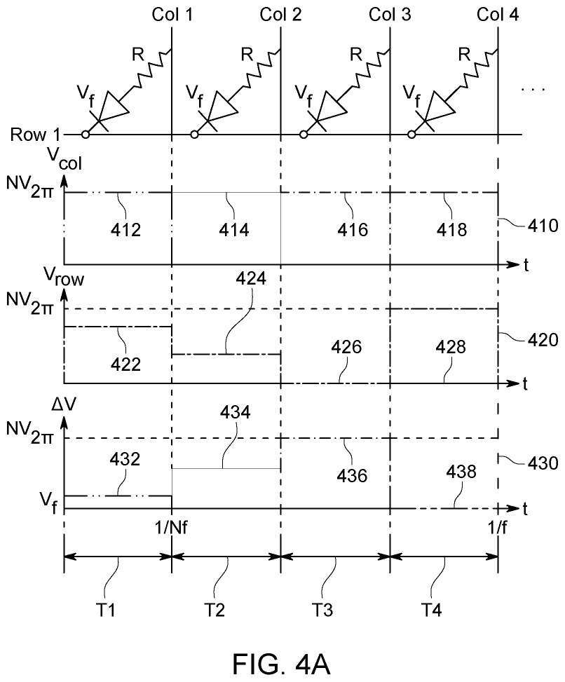

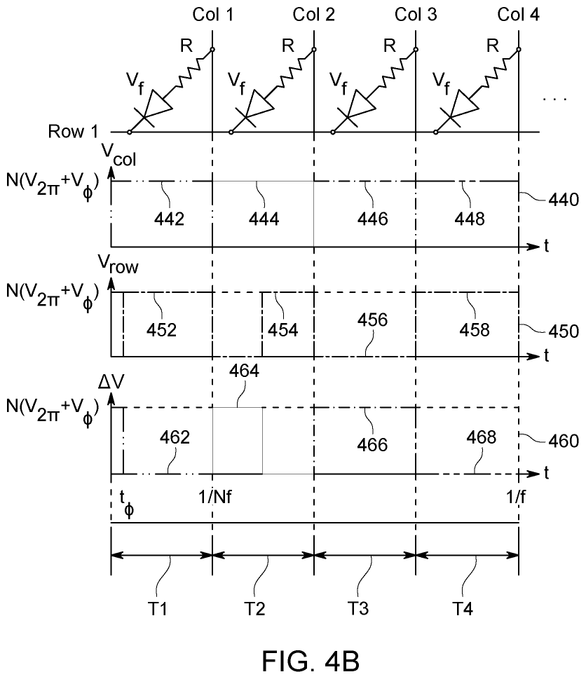

Electrical signals used to modulate the TOPS are time multiplexed across multiple columns. Accordingly, each TOPS receives an average electrical power proportional to the duty cycle as described below with reference to FIGS. 4A and 4B. In some embodiments, the average electrical power received by each TOPS can be controlled either by pulse-amplitude modulation (PAM) or pulse-width modulation (PWM) of the row voltages.

In one embodiment, a thermal crosstalk correction algorithm based on matrix inversion is used to calibrate the TOPS arrays, both when individually addressed or when addressed in a row-column architecture. Embodiments of the present disclosure provide an ordinary differential equation (ODE) based thermal excitation model of the TOPS arrays in a feedback form to tune the thermal crosstalk correction value. The thermal crosstalk correction algorithm (also referred to herein as model) also includes parameter extraction that are used to fit the model for any arbitrary TOPS array, as is described further below.

The refractive index of a TOPS is dependent on the temperature. The phase shift Φ of a TOPS is related to its refractive index as shown below:

$$Φ = 2 π L \frac{n}{{λ}_{0}} \qquad ( 1 )$$

In expression (1), λ₀ is the wavelength in free space and L is the length of the heated waveguide. The change in the phase shift ΔΦ may then be defined as:

$$ΔΦ = \frac{2 π L}{{λ}_{0}} Δ n = \frac{2 π L}{{λ}_{0}} γΔ T \qquad ( 2 )$$

In expression (2), parameter ΔT is the temperature difference, and γ is the temperature coefficient of the refractive index. Accordingly, ΔT_{π} temperature difference for a π phase shift may be written as:

$$Δ {T}_{π} = \frac{{λ}_{0}}{2 L γ} \qquad ( 3 )$$

A single TOPS may be modeled as a simple RC circuit, according to which the power P_{π} required for a π phase shift may be written as:

$${P}_{π} = Ak Δ {T}_{π} = Ak \frac{{λ}_{0}}{2 L γ} \qquad ( 4 )$$

In expression (4), A is the effective surface area and k is the effective thermal conductivity between the waveguide and the heat sink. In the RC model, 1/R=Ak is the thermal conductance of TOPS to the heat sink. The time constant τ associated with a TOPS may be similarly defined in a first-order RC approximation of the TOPS as a time-varying lumped model:

$$τ = \frac{C}{Ak} \qquad ( 5 )$$

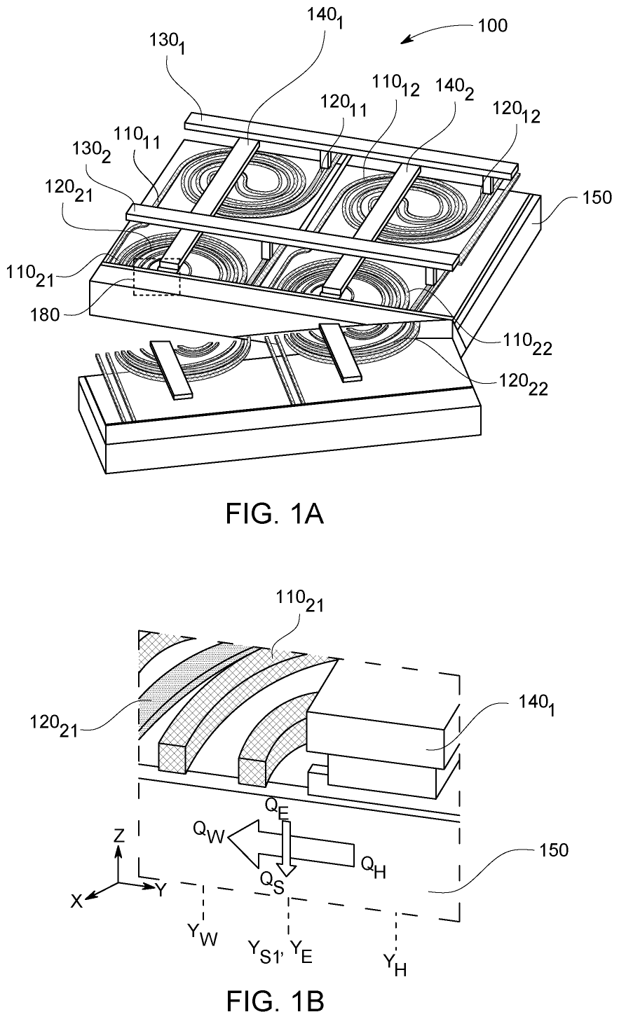

FIG. 1A is a combined perspective and cross-sectional view of a 2×2 array 100 of TOPS forming a portion of a larger array of TOPS. Each element of the array is shown as including a waveguide 110ᵢⱼ (shown in a relatively lighter shade) and an associated heater 120ᵢⱼ (shown in a relatively darker shade), where i and j are respectively row and column indices each ranging from 1 to 2 in this example. For example, disposed at the intersection of the first row and first column is waveguide 110₁₁ having an associated heating element 120₁₁ disposed between the spiral arms of waveguide 110₁₁. Column select line 140₁ is used to forward bias the diode (not shown in FIG. 1A for simplicity) associated with waveguide 110₁₁, whereas row select line 130₁ is used to set the amplitude of the electrical signal applied to the diode. The waveguides, heating elements, diodes, row and column select lines, and all components of the TOPS array are fully integrated on substrate 150.

FIG. 1B is an expanded view of the cross-section of the region 180 of the array shown in FIG. 1A. FIGS. 1B shows a portion of waveguide 110₂₁, heating element 120₂₁ and column select line 140₁ of array 100. Although the heating element (also referred to herein as heater) is shown as being on one side of the waveguide in the XYZ coordinate system, it is understood that the heater may be on both sides of the waveguide.

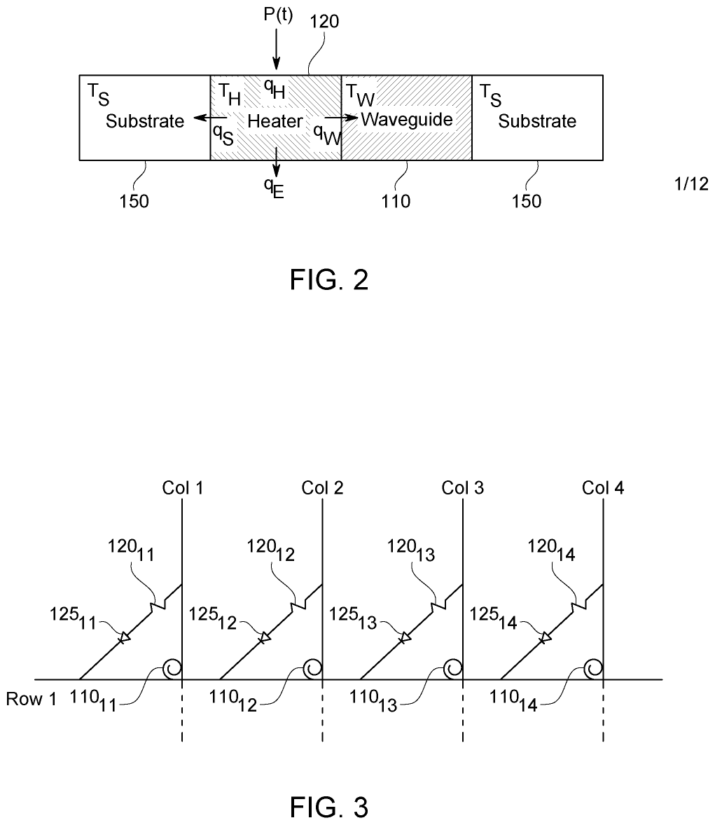

FIG. 2 shows the direction of the heat flow from a heating element 120 of the TOPS array to an associated waveguide 110, to substrate 150 (from both the waveguide and the heating element), as well as to the environment. The heat energy generated from applying electrical power P(t) to the heating element is identified as q_{H}; the temperature of the heating element is identified as T_{H}. The heat transferred to the waveguide from the heating element is identified as q_{W}; the temperature of the waveguide element is identified as T_{w}. The heat transferred to the substrate from the heating element is identified as qₛ: the temperature of the substrate element is identified as Tₛ. The heat transferred to the surrounding environment from the heating element is identified as q_{E}.

In the following, the dynamics of the heat transfer between the heater, waveguide, substrate, and the environment is analyzed while considering the environment as a perfect heat sink. Assume uniform material for all structures (e.g., heater, waveguide, substrate), and uniform temperature distribution within each structure in the X and Z directions. A time-varying temperature function, T(y, t) is used to characterizes the local instantaneous temperature. When an electrical power P(t) is applied to the heater (formed using a resistive element), the power is dissipated through four mechanisms (ignoring power dissipated in forms other than Joule heating), as described below.

The heat qu that is used to increase the heater temperature may be written as q_{H}=ρ_{H}c_{H}dT(y, t)dV where ρ_{H}, c_{H} and V are the heater mass density, specific heat capacity and volume, respectively. The heat exchange between the heater and the waveguide q_{W} may be written as q_{W}=−k_{WH}dtd\vec{A}·\vec{∇T}(y, t) where k_{WH} is the effective thermal conductivity between the waveguide and the heater, d\vec{A} is the differential surface area vector, and \vec{∇T}(y, t) is the instantaneous temperature gradient. The heat exchange between the heater and the substrate q_{S} may be written as q_{S}=−k_{SH}dtd\vec{A}·\vec{∇T}(y, t) where k_{SH} is the effective thermal conductivity between the substrate and the heater. The heat exchange with the surrounding environment q_{E}, other than the waveguide and substrate, may be written as q_{E}=−k_{EH}dtd\vec{A}·\vec{∇T}(y, t) where k_{EH} is the effective thermal conductivity between the environment and the heater.

### No Crosstalk

Assuming that the crosstalk between the phase shifters can be ignored, for a TOPS with its associated heater, waveguide and the substrate, the following expression applies:

$$dP ( t ) dt = {q}_{H} + {q}_{W} + {q}_{S} + {q}_{E}$$

where dP(t)dt represents the amount of work used to generate the sum of the four components of heat energy. A partial differential equation (PDE) for the heater may be written as:

$$dP ( t ) = \frac{1}{dt} ( {q}_{H} + {q}_{W} + {q}_{S} + {q}_{E} ) = {ρ}_{H} {c}_{H} dV \frac{\partial }{\partial t} T ( y , t ) - {k}_{WH} d \vec{A} \cdot \vec{∇ T} ( y , t ) - {k}_{SH} d \vec{A} \cdot \vec{∇ T} ( y , t ) - {k}_{EH} d \vec{A} \cdot \vec{∇ T} ( y , t ) \qquad ( 5 )$$

Since the temperature gradient is uniform over the surface area, then d\vec{A}\vec{∇T}(y, t)=dA∇T(y, t). Accordingly:

$$\frac{dP ( t )}{dV} = {ρ}_{H} {c}_{H} \frac{\partial }{\partial t} T ( y , t ) - {k}_{WH} ∇ T ( y , t ) \frac{1}{dy} - {k}_{SH} ∇ T ( y , t ) \frac{1}{dy} - {k}_{EH} ∇ T ( y , t ) \frac{1}{dy} \qquad ( 6 )$$

Integrating over the volume yields:

$${\int }_{V} ( \frac{dP ( t )}{dV} ) d = {\int }_{V} {ρ}_{H} {c}_{H} \frac{\partial T ( y , t )}{\partial t} dV - {\int }_{{A}_{WH}} {k}_{WH} ∇ T ( y , t ) dA - {\int }_{{A}_{SH}} {k}_{SH} ∇ T ( y , t ) dA - {\int }_{{A}_{EH}} {k}_{EH} ∇ T ( y , t ) dA \qquad ( 7 )$$

In the above expression (7), the relationships dV=dxdydz and dA=dxdz are used, thus yielding:

$$P ( t ) = {C}_{H} \frac{\partial T ( y , t )}{\partial t} - {A}_{WH} {k}_{WH} ∇ T ( y , t ) - {A}_{SH} {k}_{SH} ∇ T ( y , t ) - {A}_{EH} {k}_{EH} ∇ T ( y , t ) \qquad ( 8 )$$

In expression (8), C_{H} is the heat capacity of the heater. Simplifying expression (8) provides:

$$P ( t ) = {C}_{H} \frac{\partial T ( y , t )}{\partial t} - ( {G}_{WH} ) \frac{\partial T ( y , t )}{\partial y} ( {G}_{SH} ) \frac{\partial T ( y , t )}{\partial y} - ( {G}_{WH} ) \frac{\partial T ( y , t )}{\partial y} \qquad ( 9 )$$

In expression (9), Gᵢⱼ=Aᵢⱼkᵢⱼ, and A and k are the physical parameters defined in (5). Expression (9) describes the process through which the applied electrical power is expended to increase the temperature of the heater, which in turn, drives the heat exchange between the heater, the waveguide, and the substrate. Ignoring the power dissipated in forms other than Joule heating, the power exchanged with the waveguide is expended through the (i) heat used to increase the waveguide temperature; (ii) heat exchange with the substrate; and (iii) heat exchange with the surrounding environment other than the substrate). Therefore:

$${C}_{W} \frac{\partial T ( y , t )}{\partial t} = - {G}_{WH} \frac{\partial T ( y , t )}{\partial y} - {G}_{SW} \frac{\partial T ( y , t )}{\partial y} - {G}_{EW} \frac{\partial T ( y , t )}{\partial y} \qquad ( 10 )$$

In expression (10), C_{W} represents the heat capacity of the waveguide, G_{SW} represents the thermal coupling between the waveguide and the substrate represents, and G_{EW} represents the thermal coupling between the waveguide and the environment. Similarly, a PDE for the substrate may be written as:

$${C}_{S} \frac{\partial T ( y , t )}{\partial t} = - {G}_{SH} \frac{\partial T ( y , t )}{\partial y} - {G}_{SW} \frac{\partial T ( y , t )}{\partial y} - {G}_{ES} \frac{\partial T ( y , t )}{\partial y} \qquad ( 11 )$$

In expression (11), C_{S} represents the heat capacity of the substrate, and G_{ES} represents the thermal coupling between the substrate and the environment. Based on the assumption of a uniform temperature distribution within all structures in all directions, spatial temperature distribution within each structure may be ignored, thus simplifying the spatial partial derivatives to a lumped model. For a linearly-varying spatial temperature distribution within each structure, the following expression may thus be written:

$${G}_{ij} \frac{\partial T ( y , t )}{\partial y} = {A}_{ij} {k}_{i} \frac{Δ {T}_{i}}{Δ {y}_{i}} + {A}_{ij} {k}_{ij} Δ {T}_{ij} + {A}_{ij} {k}_{j} \frac{Δ {T}_{j}}{Δ {y}_{j}} \qquad ( 12 )$$

In expression (12), ΔTᵢ represents the temperature difference within structure i, ΔTᵢⱼ represents the temperature difference at the interface of structures i and j at their interface, kᵢ represents the thermal conductivity of the structure i, and kᵢⱼ represents the thermal contact conductivity between the structures i and j. Considering only the heat flow at the interfaces between structures, Gᵢⱼ reduces to Aᵢⱼkᵢⱼ, where kᵢⱼ represents the thermal contact conductivity between the structures i and j. Defining T_{H}, T_{W}, T_{S}, and T_{E} as lumped time-varying temperatures for the heater, waveguide, substrate and environment, respectively, expression (9) may be simplified as shown below:

$$P = {C}_{H} \frac{{dT}_{H}}{dt} - ( {G}_{WH} ) ( {T}_{W} - {T}_{H} ) - {G}_{SH} ( {T}_{S} - {T}_{H} ) - {G}_{EH} ( {T}_{E} - {T}_{H} ) \qquad ( 13 )$$

Similarly, expression (10) may be written as:

$${C}_{W} \frac{{dT}_{W}}{dt} = {G}_{WH} ( {T}_{H} - {T}_{W} ) + {G}_{SW} ( {T}_{S} - {T}_{W} ) + {G}_{EW} ( {T}_{E} - {T}_{W} ) \qquad ( 14 )$$

In a similar manner, expression (11) may be written as:

$${C}_{S} \frac{{dT}_{S}}{dt} = {G}_{SH} ( {T}_{H} - {T}_{S} ) + {G}_{SW} ( {T}_{W} - {T}_{S} ) + {G}_{ES} ( {T}_{E} - {T}_{S} ) \qquad ( 15 )$$

Using expression (13), (14) and (15), an ODE matrix for the lumped system in the absence of cross-talk may be defined as shown below:

$$\frac{d}{dt} [ \begin{matrix}{T}_{H} \\ {T}_{W} \\ {T}_{S}\end{matrix} ] = [ \begin{matrix}- \frac{{D}_{H}}{{C}_{H}} & \frac{{G}_{WH}}{{C}_{H}} & \frac{{G}_{SH}}{{C}_{H}} \\ \frac{{G}_{WH}}{{C}_{W}} & - \frac{{D}_{W}}{{C}_{W}} & \frac{{G}_{SW}}{{C}_{W}} \\ \frac{{G}_{SH}}{{C}_{S}} & \frac{{G}_{SW}}{{C}_{S}} & - \frac{{D}_{S}}{{C}_{S}}\end{matrix} ] [ \begin{matrix}{T}_{H} \\ {T}_{W} \\ {T}_{S}\end{matrix} ] + [ \begin{matrix}\frac{P + {G}_{EH} {T}_{E}}{{C}_{H}} \\ \frac{{G}_{EW} {T}_{E}}{{C}_{W}} \\ \frac{{G}_{ES} {T}_{E}}{{C}_{S}}\end{matrix} ] \qquad ( 16 )$$

In expression (16), Gᵢⱼ=Aᵢⱼkᵢⱼ. Since temperature distribution within each structure is assumed to be uniform, ky reduces to thermal contact conductivity between the respective structures i and j. Furthermore in expression (16), D_{H}=G_{WH}+G_{SH}+G_{EH}, D_{W}=G_{WH}+G_{SW}+G_{EW}, and D_{S}=G_{SH}+G_{SW}+G_{ES} represent the sum of thermal conductances for the diagonal elements of the matrix. Since the environment acts as a heat sink, T_{E} is constant. Moreover, because the substrate facilitates the thermal conduction between structures, the following expressions, collectively identified as expression (17) apply:

$$\frac{1}{{G}_{EW}} = \frac{1}{{G}_{ES}} + \frac{1}{{G}_{SW}} \qquad ( 17 )$$

$$\frac{1}{{G}_{EH}} = \frac{1}{{G}_{ES}} + \frac{1}{{G}_{SH}}$$

$$\frac{1}{{G}_{WH}} = \frac{1}{{G}_{SW}} + \frac{1}{{G}_{SH}}$$

### With Crosstalk

The following includes the effect of crosstalk between phase shifters and provides the analysis by scaling the single TOPS model to N phase shifters. If there are N phase shifters, for phase shifter i, expression (9) may be written as:

$${P}_{i} ( t ) = {C}_{H , i} \frac{\partial T ( y , t )}{\partial t} - {\sum }_{j = 1}^{N} ( {G}_{H , iH , j} \frac{\partial T ( y , t )}{\partial y} ) - {\sum }_{j = 1}^{N} ( {G}_{W , jH , i} \frac{\partial T ( y , t )}{\partial y} ) - {\sum }_{j = 1}^{N} ( {G}_{S , jH , i} \frac{\partial T ( y , t )}{\partial y} ) - ( {G}_{EH , i} ) \frac{\partial T ( y , t )}{\partial y} \qquad ( 18 )$$

In expression (18), Sᵢ, Wᵢ and Hᵢ respectively represent the substrate, waveguide, and heater associated with phase shifter i. Accordingly, expression (10) may be written as:

$${C}_{W , i} \frac{\partial T ( y , t )}{\partial t} = - {\sum }_{j = 1}^{N} ( {G}_{W , iH , j} \frac{\partial T ( y , t )}{\partial y} ) - {\sum }_{j = 1}^{N} ( {G}_{W , iW , j} \frac{\partial T ( y , t )}{\partial y} ) - {\sum }_{j = 1}^{N} ( {G}_{S , jW , i} \frac{\partial T ( y , t )}{\partial y} ) - {G}_{EW , i} \frac{\partial T ( y , t )}{\partial y} \qquad ( 19 )$$

Similarly expression (11) may be written as:

$${C}_{S , i} \frac{\partial T ( y , t )}{\partial t} = - {\sum }_{j = 1}^{N} ( {G}_{S , iH , j} \frac{\partial T ( y , t )}{\partial y} ) - {\sum }_{j = 1}^{N} ( {G}_{S , iW , j} \frac{\partial T ( y , t )}{\partial y} ) - {\sum }_{j = 1}^{N} ( {G}_{S , iS , j} \frac{\partial T ( y , t )}{\partial y} ) - {G}_{ES , i} \frac{\partial T ( y , t )}{\partial y} \qquad ( 20 )$$

Considering uniform temperature distributions within all structures (i.e., heater, waveguide and substrate), and defining the lumped time-varying temperatures for the heater, waveguide, substrate associated with the i^{th} TOPS as T_{H,i}, T_{W,i}, T_{S,i}, and further defining the T_{E} as the temperatures for the environment, expression (18) may be written as:

$${P}_{H , i} = {C}_{H , i} \frac{{dT}_{H , i}}{dt} = - {{\sum }^{N}}_{j = 1} [ {G}_{H , iH , j} ( {T}_{H , j} - {T}_{H , i} ) ] - {\sum }_{j = 1}^{N} {G}_{W , jH , i} ( {T}_{W , j} - {T}_{H , i} ) - {\sum }_{j = 1}^{N} [ {G}_{S , jH , i} ( {T}_{S , j} - {T}_{H , i} ) ] - {G}_{EH , i} ( {T}_{E} - {T}_{H , i} ) \qquad ( 21 )$$

Similarly expression (19) may be written as:

$${C}_{W , i} \frac{{dT}_{W , i}}{dt} = {\sum }_{j = 1}^{N} [ {G}_{W , iH , j} ( {T}_{H , j} - {T}_{W , i} ) ] + {\sum }_{j = 1}^{N} [ {G}_{W , iW , j} ( {T}_{W , j} - {T}_{W , i} ) ] + {\sum }_{j = 1}^{N} [ {G}_{S , jS , i} ( {T}_{S , j} - {T}_{W , i} ) ] - {G}_{ES , i} ( {T}_{E} - {T}_{W , i} ) \qquad ( 22 )$$

In a similar manner expression (20) may be written as:

$${C}_{S , i} \frac{{dT}_{S , i}}{dt} = {\sum }_{j = 1}^{N} [ {G}_{S , iH , j} ( {T}_{H , j} - {T}_{S , i} ) ] + {\sum }_{j = 1}^{N} [ {G}_{S , iW , j} ( {T}_{W , j} - {T}_{S , i} ) ] + {\sum }_{j = 1}^{N} [ {G}_{S , jS , i} ( {T}_{S , j} - {T}_{S , i} ) ] + {G}_{ES , i} ( {T}_{E} - {T}_{S , i} ) \qquad ( 23 )$$

Using expressions (21), (22), and (23), the following generalized matrix ODE may be written:

$${D}_{H , i} = {G}_{H , iH} + {G}_{WH , i} + {G}_{SH , i} + {G}_{EH , i}$$

$${D}_{W , i} = {G}_{W , iH} + {G}_{W , iW} + {G}_{SW , i} + {G}_{EW , i}$$

$${D}_{S , i} = {G}_{S , iH} + {G}_{S , iW} + {G}_{S , iS} + {G}_{ES , i}$$

where:

$${G}_{H , iH} = {\sum }_{j = 1}^{N} ( {G}_{H , iH , j} ) - {G}_{H , iH , i}$$

$${G}_{WH , i} = {\sum }_{j = 1}^{N} ( {G}_{W , jH , i} )$$

$${G}_{SH , i} = {\sum }_{j = 1}^{N} ( {G}_{S , jH , i} )$$

$${G}_{W , iH} = {\sum }_{j = 1}^{N} ( {G}_{W , iH , j} )$$

$${G}_{W , iW} = {\sum }_{j = 1}^{N} ( {G}_{W , iW , j} ) - {G}_{W , iW , i}$$

$${G}_{SW , i} = {\sum }_{j = 1}^{N} ( {G}_{S , jW , i} )$$

$${G}_{S , iH} = {\sum }_{j = 1}^{N} ( {G}_{S , iH , j} )$$

$${G}_{S , iW} = {\sum }_{j = 1}^{N} ( {G}_{S , iW , j} )$$

$${G}_{S , iS} = {\sum }_{j = 1}^{N} ( {G}_{S , iS , j} ) - {G}_{S , i , S , i}$$

The following matrix ODE may then be written:

$$\frac{d}{dt} [ \begin{matrix}{T}_{H , 1} \\ ⋮ \\ {T}_{H , N} \\ {T}_{W , 1} \\ ⋮ \\ {T}_{W , N} \\ {T}_{S , 1} \\ ⋮ \\ {T}_{S , N}\end{matrix} ] = M [ \begin{matrix}{T}_{H , 1} \\ ⋮ \\ {T}_{H , N} \\ {T}_{W , 1} \\ ⋮ \\ {T}_{W , N} \\ {T}_{S , 1} \\ ⋮ \\ {T}_{S , N}\end{matrix} ] + [ \begin{matrix}\frac{{P}_{1} + {G}_{EH , 1} {T}_{E}}{{C}_{H , 1}} \\ ⋮ \\ \frac{{P}_{N} + {G}_{EH , N} {T}_{E}}{{C}_{H , N}} \\ \frac{{G}_{EW , 1} {T}_{E}}{{C}_{W , 1}} \\ ⋮ \\ \frac{{G}_{EW , N} {T}_{E}}{{C}_{W , N}} \\ \frac{{G}_{ES , 1} {T}_{E}}{{C}_{S , 1}} \\ ⋮ \\ \frac{{G}_{ES , N} {T}_{E}}{{C}_{S , N}}\end{matrix} ] \qquad ( 24 )$$

In expression (24), matrix M is defined as:

$$[ \begin{matrix}- \frac{{D}_{H , 1}}{{C}_{H , 1}} & ⋯ & \frac{( {G}_{H , 1 H , N} )}{( {C}_{H , 1} )} & \frac{{G}_{W , 1 H , 1}}{{C}_{H , 1}} & ⋯ & \frac{( {G}_{W , NH , 1} )}{( {C}_{H , 1} )} \frac{{G}_{S , NH , 1}}{{C}_{H , 1}} & \frac{{G}_{S , 1 H , 1}}{{C}_{H , 1}} & ⋯ & \frac{{G}_{S , NH , 1}}{{C}_{H , 1}} \\ ⋮ & ⋱ & ⋮ & ⋮ & ⋱ & ⋮ & ⋮ & ⋱ & ⋮ \\ \frac{( {G}_{H , 1 H , N} )}{( {C}_{H , N} )} & ⋯ & - \frac{{D}_{H , N}}{{C}_{H , N}} & \frac{( {G}_{W , 1 H , N} )}{( {C}_{H , N} )} & ⋯ & \frac{{G}_{W , NH , N}}{{C}_{H , N}} & \frac{{G}_{S , 1 H , N}}{{C}_{H , N}} & ⋯ & \frac{( {G}_{S , NH , N} )}{( {C}_{H , N} )} \\ \frac{{G}_{W , 1 H , 1}}{{C}_{W , 1}} & … & \frac{{G}_{W , 1 H , N}}{{C}_{W , 1}} & - \frac{{D}_{W , 1}}{{C}_{W , 1}} & ⋯ & \frac{{G}_{W , 1 W , N}}{{C}_{W , 1}} & \frac{{G}_{S , 1 W , 1}}{{C}_{W , 1}} & ⋯ & \frac{{G}_{S , NW , 1}}{{C}_{W , 1}} \\ ⋮ & ⋱ & ⋮ & ⋮ & ⋱ & ⋮ & ⋮ & ⋱ & ⋮ \\ \frac{{G}_{W , NH , 1}}{{C}_{W , N}} & ⋯ & \frac{{G}_{W , NH , N}}{{C}_{W , N}} & \frac{{G}_{W , NW , 1}}{{C}_{W , N}} & ⋯ & - \frac{{D}_{W , N}}{{C}_{W , N}} & \frac{{G}_{S , 1 W , N}}{{C}_{W , N}} & ⋯ & \frac{{G}_{S , NH , N}}{{C}_{W , N}} \\ \frac{{G}_{S , 1 H , 1}}{{C}_{S , 1}} & ⋯ & \frac{{G}_{S , 1 H , N}}{{C}_{S , 1}} & \frac{{G}_{S , 1 W , 1}}{{C}_{S , 1}} & ⋯ & \frac{{G}_{S , 1 W , N}}{{C}_{S , 1}} & - \frac{{D}_{S , 1}}{{C}_{S , 1}} & ⋯ & \frac{{G}_{S , 1 S , N}}{{C}_{S , 1}} \\ ⋮ & ⋱ & ⋮ & ⋮ & ⋱ & ⋮ & ⋮ & ⋱ & ⋮ \\ \frac{{G}_{S , NH , 1}}{{C}_{S , N}} & ⋯ & \frac{{G}_{S , NH , N}}{{C}_{S , N}} & \frac{{G}_{S , NW , 1}}{{C}_{S , N}} & ⋯ & \frac{{G}_{S , NW , N}}{{C}_{S , N}} & \frac{{G}_{S , NS , 1}}{{C}_{S , N}} & ⋯ & - \frac{{D}_{S , N}}{{C}_{S , N}}\end{matrix} ] \qquad ( 25 )$$

Because the substrate facilitates the thermal conduction between various structures, for cach TOPS the following apply:

$$\frac{1}{{G}_{EW , i}} = \frac{1}{{G}_{ES , i}} + \frac{1}{{G}_{S , iW , i}} \qquad ( 26 )$$

$$\frac{1}{{G}_{EH , i}} = \frac{1}{{G}_{ES , i}} + \frac{1}{{G}_{S , iH , i}}$$

$$\frac{1}{{G}_{W , iH , i}} = \frac{1}{{G}_{S , iH , i}} + \frac{1}{{G}_{S , iW , i}}$$

Therefore, the crosstalk between the TOPS is due to G_{S,iS,j}, thus yielding:

$$\frac{1}{{G}_{H , iH , j}} = \frac{1}{{G}_{S , iH , i}} + \frac{1}{{G}_{S , jH , j}} + \frac{1}{{G}_{S , iS , j}} \qquad ( 27 )$$

$$\frac{1}{{G}_{W , iW , j}} = \frac{1}{{G}_{S , iW , i}} + \frac{1}{{G}_{S , jW , j}} + \frac{1}{{G}_{S , iS , j}}$$

$$\frac{1}{{G}_{W , iH , j}} = \frac{1}{{G}_{S , iH , i}} + \frac{1}{{G}_{S , jW , j}} + \frac{1}{{G}_{S , iS , j}}$$

$$\frac{1}{{G}_{S , iH , j}} = \frac{1}{{G}_{S , jH , j}} + \frac{1}{{G}_{S , iS , j}}$$

$$\frac{1}{{G}_{S , iW , j}} = \frac{1}{{G}_{S , jW , j}} + \frac{1}{{G}_{S , iS , j}}$$

For any array of phase shifters, the above system of ODEs may be solved numerically or through variation of parameters to obtain the time-domain response of the heaters, waveguides, and substrate. This enables fast modeling of large-scale TOPS arrays without the need for computationally-intensive finite element method (FEM) simulations, thereby enabling efficient analysis of the driving waveforms for any arbitrary system of parameters.

### TOPS Array

FIG. 3 is a schematic diagram of row 1 and columns 1-4 of the TOPS array described above with reference to FIG. 1A. Waveguides 110₁₁, 110₁₂, 110₁₃, and 110₁₄ are shown as being disposed at the intersection of row 1 and columns 1-4 respectively. Associated with each waveguide is a resistor and a diode. For example, resistor 120₁₁ disposed between row 1 and column 1 is associated with and used to control the amount of heat applied to and thereby adjust the phase of the light passing through waveguide 110₁₁.

Furthermore, associated with each waveguide is a diode operating as a switch to enable a current to flow in order to modulate the diode's associated phase shifter. For example, diode 125₁₁ disposed between row 1 and column 1 is associated with and used to control the phase shift of the light travelling through waveguide 110₁₁ by controlling the amount of current passing through resistor 120₁₁. Therefore, a selected column determines the diode which will be forward biased, and a selected row determines the amplitude of the electrical signal though the diode.

FIGS. 4A and 4B show exemplary voltages that may be applied to the array of TOPS shown in FIG. 3. Plot 410 of FIG. 4A shows the pulse-amplitude modulated (PAM) voltage waveforms 412, 414, 416 and 418 that are respectively applied to columns (col) 1, 2, 3 and 4 of the array, during respective time periods T₁, T₂, T₃ and T₄, to cause a 2π phase shift. It is assumed that the array include N columns hence the voltage applied to the columns is show as NV_{2π}. Plot 420 of FIG. 4A shows the PAM voltage waveforms 422, 424, 426, and 428 that are respectively applied to row 1 of the array during respective time periods T₁, T₂, T₃ and T₄, to cause a 2π phase shift. Plot 430 of FIG. 4A shows the difference between the column voltages 410 and row voltages 420 received by the associated TOPS during time periods T₁, T₂, T₃ and T₄.

In a similar manner, plot 440 of FIG. 4B shows the pulse-width modulated (PWM) voltage waveforms 442, 444, 446 and 448 that are respectively applied to columns 1, 2, 3 and 4 of the array, during respective time periods T₁, T₂, T₃ and T₄, to cause a 2π phase shift. It is assumed that the array include N columns hence the voltage applied to the columns is show as N(V_{2π}+V_{Ø}), where V_{Ø} represents a relatively small voltage required to cause a 2π phase shift. Plot 450 of FIG. 4B shows the PWM voltage waveforms 452, 454, 456, and 458 that are respectively applied to row 1 of the array during respective time periods T₁, T₂, T₃ and T₄, to cause a 2π phase shift. Plot 460 of FIG. 4B shows the difference between the column voltages 440 and row voltages 450 received by the associated TOPS during time periods T₁, T₂, T₃ and T₄.

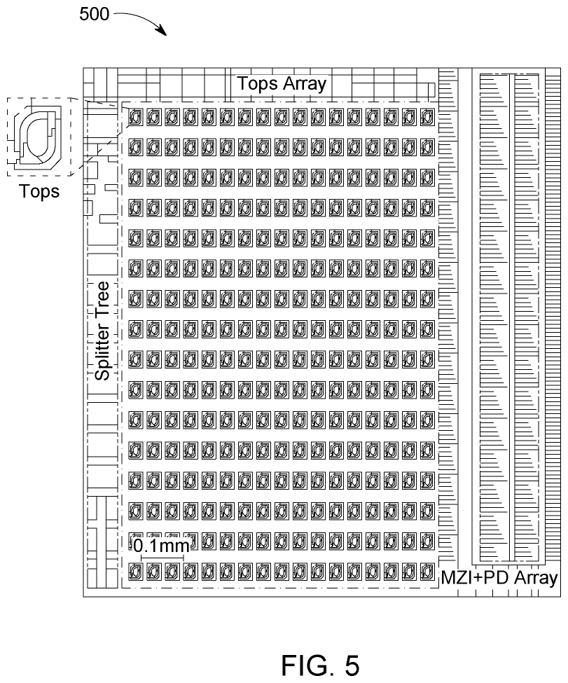

FIG. 5 is a micrograph 500 of an example of an array of 288 TOPS arranged along 32 rows and 9 columns and formed on a silicon substrate. The array uses a folded architecture in which two electrical rows are fitted per one physical row with a shorter optical path length, thereby reducing the optical loss and increasing the coherence between different branches. Such an architecture reduces the electrical length of the columns by half, thus enabling the use of a smaller metal width for routing and, in turn, improving scalability. Light is coupled to the chip via a grating coupler and is distributed to the TOPS array via a 1:256 light splitter tree. Each TOPS in this example includes 300 μm of spiral waveguide surrounded by doped silicon operating as a resistor/Joule heater.

As shown in FIGS. 3, 4A and 4B, in series with each heater is an associated silicon diode to switch on/off the TOPS in the array. Switching off a diode causes the light passing through the diode's associated waveguide not to have a phase shift, and switching on a diode causes the phase of light passing through the diode's associated waveguide to shift in accordance with the difference in the voltages applied to the rows and columns to which the waveguide is connected, as described above with reference to FIGS. 4A and 4B. An oxide etch may also be formed around each TOPS to minimize thermal crosstalk.

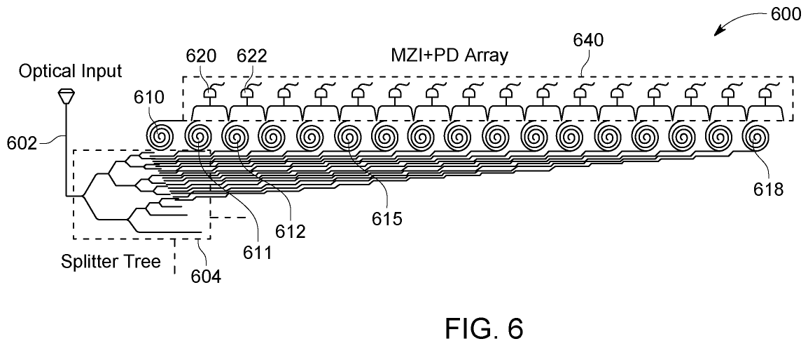

In some embodiments, a TOPS array, such as TOPS array 600 shown in FIG. 6 includes, in part, a splitter tree 604 that splits the received optical signals 602 into as many TOPS as there are in the array. The exemplary array 600 is further shown as including, in part, 9 columns and 2 rows of TOPS that are folded into one physical row. Only 17 of the 18 waveguides, namely waveguides 610, 611 . . . 618 are shown in FIG. 6. Also included in the array 600 are a multitude of Mach-Zehnder interferometers (MZI) and photodiodes each associated with a different one of TOPS. For example, the light passing through waveguides 610, 611 is delivered to an associated MZI (not shown for simplicity), which in response generates a light having a phase defined by the difference between the phases of the lights travelling through waveguides 610 and 611. The output of the MZI is caused to impinge on a photodiode (PD) 620, which in response, generates a current characterized by the phase of the light received from the PD's associated MZI. The MZIs and their corresponding PDS are collectively shown within box 640. In one embodiment, the number of MZIs and PDs is the same as the number of phase shifters in a TOPS array.

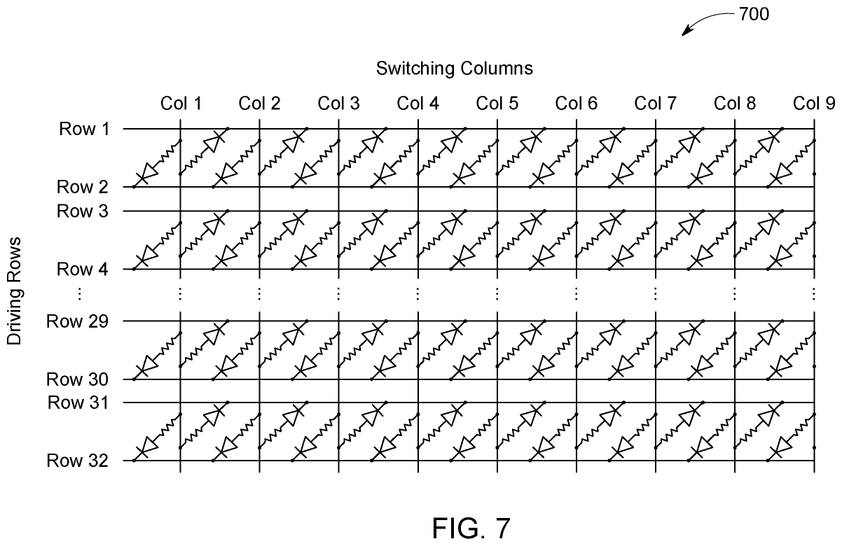

FIG. 7 shows an array 700 of TOPS folded in the direction of rows and having 32 rows and 18 columns in accordance with one exemplary embodiment of the present disclosure.

### Parameter Extraction

To determine the parameters used in the thermal model as described by expressions 24 and 25 above, a parameter extraction method is described herein. The method provides, in part, three parameters that characterize a TOPS array with some assumptions to simplify the aforementioned ODE, described by expression (24). The parameters may be extracted either from simulation or from a TOPS test structure. Such a test structure may include, for example, a pair of TOPS (i.e., waveguides, heater and the diode), an MZI and a PD.

The three parameters that are extracted from the either simulation or test structure include (i) the electrical power required to apply a π phase shift to the TOPS, referred to herein a P_{π}, (ii) the time constant or the electrical bandwidth of TOPS, referred to herein as τ; and (iii) and the electrical power P_{π}⁽¹⁾ required to induce a x phase shift at a first TOPS by applying the electrical power to a second TOPS adjacent the first TOPS. The first two parameters characterize a TOPS individually, whereas the third parameter characterizes the first-order crosstalk. Higher-order crosstalk effects are negligible and therefore are not used in some exemplary embodiments of the present disclosure. In other exemplary embodiments, higher-order crosstalk effects/parameters may be derived from the first-order crosstalk parameters and substrate material properties.

With the aforementioned simplifications, the extracted parameters (P_{π}, τ, P_{π}⁽¹⁾) are related to parameters used in the model using expressions (3), (4) and (5) resulting in:

$$\frac{1}{G} = 12 \frac{Δ {T}_{π}}{{P}_{π}} = \frac{6 {λ}_{0}}{{P}_{π} L γ} \qquad ( 28 )$$

$${C}_{W} = \frac{5}{2} G τ \qquad ( 29 )$$

$$\frac{1}{{G}_{SS}^{( 1 )}} \approx 12 \frac{{P}_{π}^{( 1 )}}{4 {G}^{2} Δ {T}_{π}} = \frac{{P}_{π}^{( 1 )} L γ}{2 {G}^{2} {λ}_{0}} \qquad ( 30 )$$

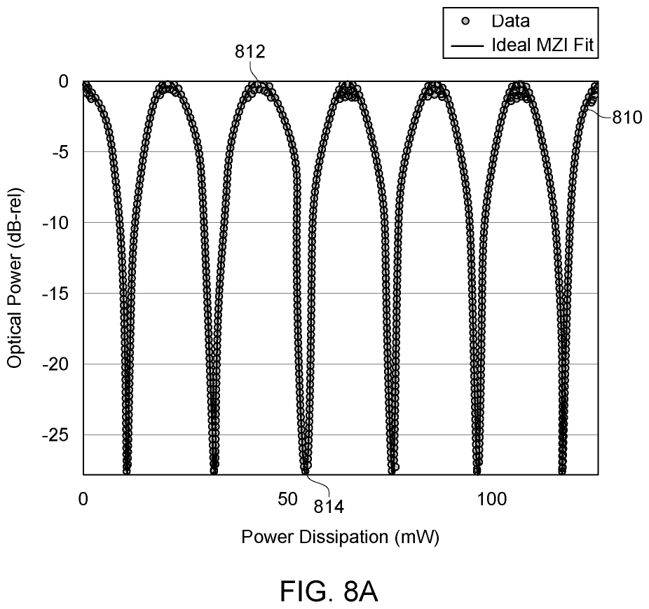

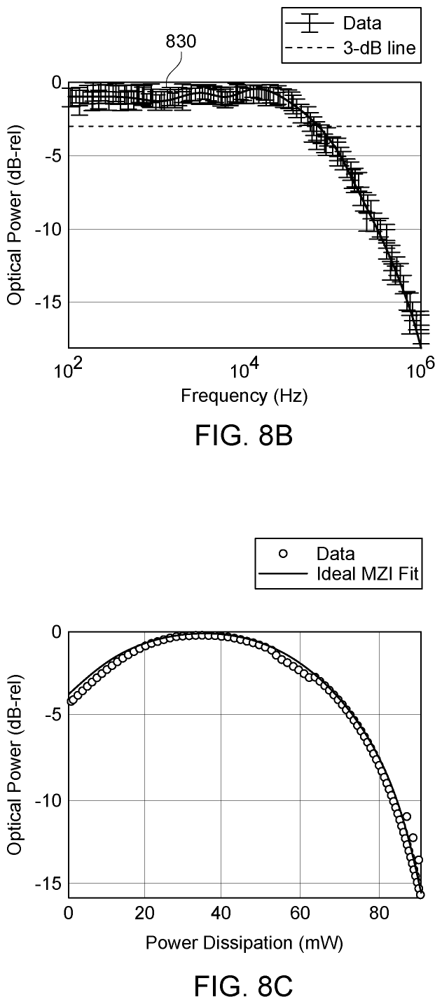

Results from an exemplary parameter extraction are described below with reference to FIGS. 8A, 8B and 8C. FIG. 8A shows a plot 810 of the optical power supplied by an MZI of an associated waveguide (y-axis) as a function of the power applied to the resistor of the associated waveguide (x-axis). Plot 810 shows a P_{π} of 10.6 mW defined by the difference between a pair of neighboring peak (e.g., 812) and trough (e.g., 814) of the plot.

FIG. 8B shows a plot 830 of the optical power supplied by an MZI of an associated waveguide as a function of the frequency. The time constant is defined at the 3-db point, namely point A at which the bandwidth is 56.8 kHz corresponding to a time constant τ of 17.5 μs.

FIG. 8C shows a plot 850 of the optical power output by an MZI of an associated waveguide generated in response to a power applied to a neighboring TOPS. As seen from FIG. 8C, parameter P_{π}⁽¹⁾ has a value of 62.6$ mW. Parameters P_{π} and τ correspond to C_{W}=440 pJ/K and G=G_{SW}=G_{SH}=62.8 μW/K, and parameter P_{π}⁽¹⁾ of 62.6 mW corresponds to G_{SS}¹=4.26 μW/K.

Therefore, in accordance with one aspect of the present disclosure, using a test structure (or simulation), all the parameters of matrix M shown in expression (25) above may be determined. Similarly, all the parameters in the matrices shown on the right hand side of expression (24) may be determined in a similar manner. The vector of temperatures on the right hand side of expression (24) is established at the beginning defining the initial conditions. Therefore, the time rate of change

$$( \frac{d}{dt} )$$

of the various temperatures shown in the matrix on the left hand side of expression (24) may be determined from performing the operations shown on the right hand side of expression (24).

### Thermal Crosstalk Correction

In accordance with one aspect of the present disclosure, correction for thermal crosstalk between various TOPS may be performed in two or more steps. For an arbitrary TOPS array (with or without row-column addressing), a square matrix can be defined to relate the power applied to each TOPS to the phase shift acquired by the light passing through TOPS. In such embodiments, assuming a linear system

$$( \frac{\partial ϕ}{\partial P} = constant )$$

the steady-state coupling matrix may be defined as:

$$[ \begin{matrix}{Φ}_{1} \\ {Φ}_{2} \\ {Φ}_{3} \\ ⋮\end{matrix} ] = [ \begin{matrix}{C}_{11} & {C}_{12} & {C}_{13} & … \\ {C}_{12} & {C}_{22} & {C}_{23} & … \\ {C}_{13} & {C}_{23} & {C}_{33} & \\ ⋮ & ⋮ & & ⋱\end{matrix} ] [ \begin{matrix}{P}_{1} \\ {P}_{2} \\ {P}_{3} \\ ⋮\end{matrix} ] \qquad ( 28 )$$

where elements Φ₁, Φ₂, Φ₃ . . . Φₙ of the matrix are related to their associated temperatures using expression (2) described above.

The diagonal elements (Cₚₚ) of the matrix are the modulation coefficients dictated by the thermo-optic interaction within each individual TOPS, whereas the off-diagonal elements (C_{pq}) are the coupling coefficients between different TOPS. If the Φ matrix denotes the desired phase shifts, crosstalk-corrected powers can be determined simply via matrix inversion, P=C⁻¹ Φ. This is a relatively simple linear transformation, however, accurately characterizing the coupling matrix poses challenges since each matrix element varies due to fabrication variations and asymmetries in the experimental setup. However, the parameters acquired by the parameter extraction method described above enable the complete population of this matrix and initial correction with the aforementioned matrix inversion.

Expression (28) provides a steady state solution to expression (24). The initial correction obtained by solving expression (28), however, does not account for changes in the extinction ratio and the temperature due to the phase swing caused by temporal multiplexing in row-column TOPS arrays. Therefore, in accordance with another aspect of the present disclosure, feedback information, that may be generated from the simulation or a physical TOPS array, is provided to fine-tune the matrix of coupling coefficients in order to correct for changes in the extinction ratio.

### Feedback Tuning with the Thermal Excitation Model

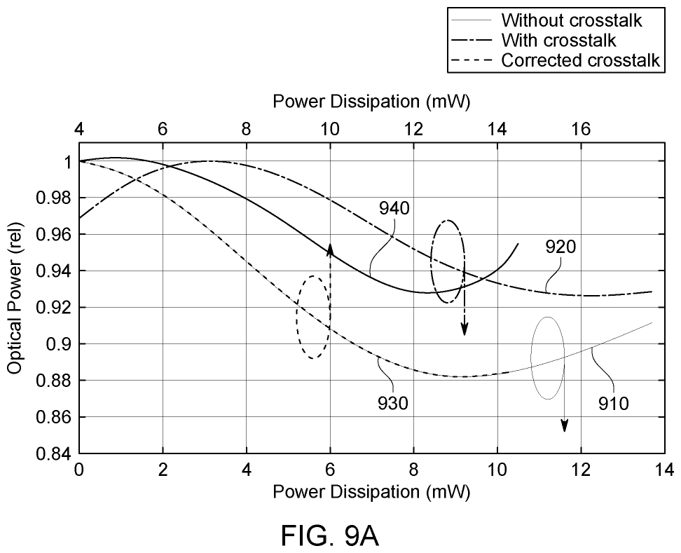

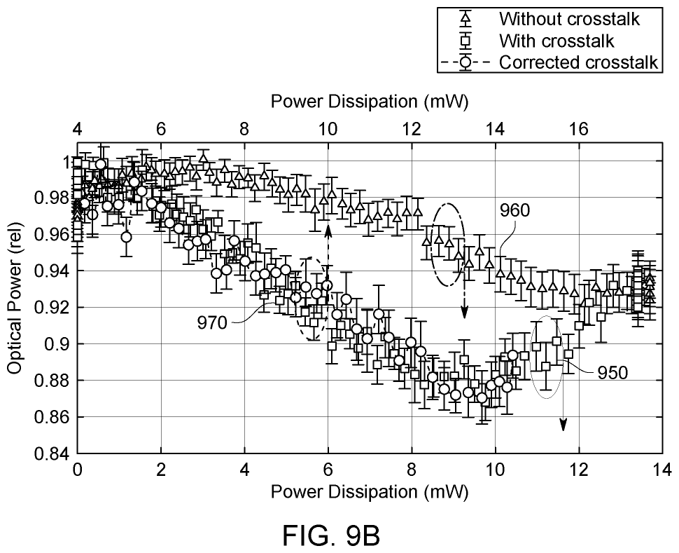

In one exemplary embodiment of this feedback tuning algorithm, a finite-difference simulation based on the thermal excitation model matrix ODE is constructed. Continuing with this exemplary embodiment, the TOPS array is driven with an initial estimate for the power vector. Then, each TOPS in the array is individually swept in electrical power to obtain an amplitude-domain response (MZI curve). This response is compared to the response acquired from the finite-difference simulation, and the parameters are fine-tuned to match the responses. Then, the corrected electrical power along with the corrected driving frequency for each TOPS is recorded. A second estimate for the electrical power vector is then determined along with the maximum driving frequency to increase the extinction ratio. This process is then repeated over multiple iterations until the values converge. Results from an exemplary embodiment of the thermal crosstalk correction process are shown in FIGS. 9A and 9B.

In accordance with one exemplary embodiment, the MZIs are used to determine the time varying behavior of the phase shifters and provide the results as feedback data to vary the voltage applied to the phase shifter's associated heaters. In another embodiment, simulation is used to generate the feedback data for tunning the heater's voltages.

FIG. 9A shows the simulated plots 910, 920 and 930 respectively associated with having (i) no crosstalk; (ii) crosstalk, and (iii) corrected crosstalk, as obtained by varying the optical power. The x-axis along the bottom shows the dissipated power corresponding to plots 910 and 920, and the x-axis along the top shows the dissipated power corresponding to plot 930. When using a finite difference based simulation, the temperatures are determined at every time step within a given time range. For example, if it is desired to characterize the behavior of a TOPS array from, e.g., time 0 to time 10 seconds, then the temperature for all the structures at each time step is used to determine the phases, form which the plots shown in FIG. 9A are obtained. For example, in FIG. 9A, plot 910, which represents no crosstalk, is associated with a given initial conditions and power dissipation.

Assume the initial conditions are changed such that more phase shifters, or the entirety of the phase shifters are driven during a simulation run. The simulation generates plot 920 representative of the presence of crosstalk. Thereafter, for example, suitable initial conditions are determined while all the other phase shifters are driven so as ensure that the hashed plot 930 coincides with plot 910. Therefore, in accordance with some embodiments, random search may be performed iteratively so as to find the right initial conditions that can correct the cross talk.

In accordance with embodiments of the present disclosure, expressions (24) and

(25) described above, may be used in the simulations used to generate plots 910, 920 and 930 to enhance the simulation speed considerably while at the same time reducing the simulation cost.

Referring again to FIG. 9A, plot 920 shows the optical power as a function of power dissipation when there is cross-talk. Plot 940 shows the optical power as a function of power dissipation obtained using expressions (24) and (25). In accordance with one embodiment of the present disclosure, plots 920 and 910 are caused to be brought into alignment along the x-axis and y-axis by tuning the parameters, such as the voltages applied to one or more heaters associated with one or more waveguides, the voltages applied to the diodes associated with the waveguide, or a frequency of the PAM or PWM voltages applied to the diodes. For example, in one embodiment, the first data set representing plot 910, and the second data set representing plot 920 are considered to have been aligned when a variance (e.g., the 3 sigma value) between the first data set and the second data set is smaller than a threshold value. When the alignment between the first and second data set becomes smaller than the threshold value, by adjusting the applied heat and voltages as described above, the corrections is considered complete. In some embodiments, the voltage signals may receive pre-emphasis (e.g., get pre-equalized) by being increased or decreased from a predefined level so as to reduce the turn-on/turn-off time of the TOPS. In some embodiments, the on-chip MZIs may be used to confirm the corrections made using simulations. In other embodiments, the on-chip MZIs may be used as feedback to provide for the corrections.

In accordance with one exemplary embodiment, the MZIs are used to determine the time varying behavior of the phase shifters and provide the determined behavior as feedback data to vary the voltage applied to the phase shifter's associated heaters. The on-chip MZIs may be used to confirm the corrections made using simulations. In other embodiments, the on-chip MZIs may be used to provide for the corrections. In another embodiment, simulation is used to generate the feedback data for tunning the heater's voltages.

FIG. 9B shows plots 950, 960 and 970 respectively associated with having (i) no crosstalk, (ii) crosstalk, and (iii) corrected crosstalk obtained by varying the optical power using measurements made on a photonic deice. Plots 950, 960 and 970 are measured plots following the simulations shown in FIG. 9A. As seen from the plots shown in FIG. 9B, the three plots 950, 960 and 970 of FIG. 9B follow the pattern of corresponding plots 910, 920 and 930 of FIG. 9A, showing full correction has been achieved in the actual TOPS array.

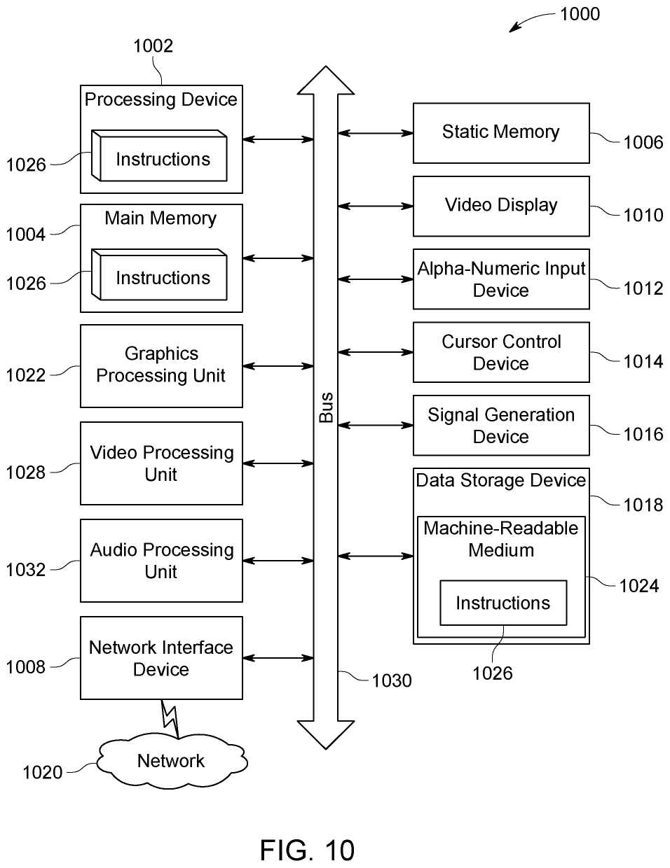

FIG. 10 illustrates an example machine of a computer system 1000 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM), a static memory 1006 (e.g., flash memory, static random access memory (SRAM), etc.), and a data storage device 1018, which communicate with each other via a bus 1030.

Processing device 1002 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 may be configured to execute instructions 1026 for performing the operations and steps described herein.

The computer system 1000 may further include a network interface device 1008 to communicate over the network 1020. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), a graphics processing unit 1022, a signal generation device 1016 (e.g., a speaker), graphics processing unit 1022, video processing unit 1028, and audio processing unit 1032.

The data storage device 1018 may include a machine-readable storage medium 1024 (also known as a non-transitory computer-readable medium) on which is stored one or more sets of instructions 1026 or software embodying any one or more of the methodologies or functions described herein. The instructions 1026 may also reside, completely or at least partially, within the main memory 1004 and/or within the processing device 1002 during execution thereof by the computer system 1000, the main memory 1004 and the processing device 902 also constituting machine-readable storage media.

In some implementations, the instructions 1026 include instructions to implement functionality corresponding to the present disclosure. While the machine-readable storage medium 1024 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 902 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

The above embodiments of the present disclosure are illustrative and not limitative. Embodiments of the present disclosure are not limited by the array size. Embodiments of the present disclosure are not limited by the wavelength of the optical source used in the array. Embodiments of the present invention are not limited to the circuitry, such as modulators, splitters, detectors, controllers, and the like. Other additions, subtractions or modifications are obvious in view of the present disclosure and are intended to fall within the scope of the appended claims.

What is claimed is:

1. A method of correcting for crosstalk amongst a plurality of thermo-optics phase shifters (TOPS) integrated on a substrate, each TOPS comprising a waveguide and an associated heater, the method comprising:
determining a first value representative of an amount of electrical power applied to a heater associated with a first TOPS causing a 180° phase shift in an optical signal passing through the TOP's associated waveguide;
determining a second value representative of a time constant of the first TOPS;
determining a third value representative of an amount of electrical power applied to a heater associated with a second TOPS causing a 180° phase shift in an optical signal passing through the waveguide associated with the first TOPS;
determining a plurality of thermal couplings between the plurality of heaters, the plurality of waveguides and a plurality of positions in the substrate using one or more of the first, second and third values; and
making, by a processor, a correction associated with the crosstalk in accordance with the determined plurality of thermal couplings.

2. The method of claim 1 wherein the one or more of the first, second and third values are determined from measurements made a on a test structure.

3. The method of claim 1 wherein the one or more of the first, second and third values are determined from computer simulations.

4. The method of claim 1 further comprising:
generating in accordance with the plurality of thermal couplings and in the absence of crosstalk, a first set of data representative of optical power output of a first one of the waveguides as a function of power applied to a heater associated with the first one of the waveguides.

5. The method of claim 2 further comprising:
generating in accordance with the plurality of thermal couplings and in the presence of crosstalk, a second set of data representative of optical power output of the first one of the waveguides as a function of power applied to the heater associated with the first one of the waveguides.

6. The method of claim 5 further comprising:
causing a variance between the first set of data and the second set of data to be less than a threshold value by changing one or more of a heat applied to the first one of the waveguides, a voltage applied to a first diode associated with the first one of the waveguides, or a frequency of the voltage applied to the first diode.

7. The method of claim 1 wherein said first and second TOPS are adjacent TOPS.

8. The method of claim 7 wherein the plurality of TOPS are disposed along a plurality of rows and a plurality of columns.

9. The method of claim 8 wherein the plurality of rows are folded.

10. The method of claim 9 wherein a plurality of Mach-Zehnder interferometers and photodetectors associated with the TOPS are integrated on the substrate.

11. The method of claim 10 wherein the first and second set of data are generated using one or more of the Mach-Zehnder interferometers.

12. A photonics system comprising: a plurality of TOPS each TOPS comprising a waveguide and an associated heater; a memory storing instructions; and a processor, coupled with the memory and to execute the instructions, the instructions when executed causing the processor to:
determine a first value representative of an amount of electrical power applied to a heater associated with a first TOPS causing a 180° phase shift in an optical signal passing through the TOPS' associated waveguide;
determine a second value representative of a time constant of the TOPS;
determine a third value representative of an amount of electrical power applied to a heater associated with a second TOPS causing a 180° phase shift in an optical signal passing through the waveguide associated with the first TOPS;
determine a plurality of thermal couplings between the plurality of heaters, the plurality of waveguides and a plurality of positions in the substrate using one or more of the first, second and third values; and
making a correction associated with the crosstalk in accordance with the determined plurality of thermal couplings.

13. The photonics system of claim 12 wherein the one or more of the first, second and third values are determined from computer simulations.

14. The photonics system of claim 13 wherein the instructions further cause the processor to generate in accordance with the plurality of thermal couplings and in the absence of crosstalk, a first set of data representative of optical power output of a first one of the waveguides as a function of power applied to a heater associated with the first one of the waveguides.

15. The photonics system of claim 14 wherein the instructions further cause the processor to generate in accordance with the plurality of thermal couplings and in the presence of crosstalk, a second set of data representative of optical power output of the first one of the waveguides as a function of power applied to the heater associated with the first one of the waveguides.

16. The photonics system of claim 15 wherein the instructions further cause the processor to:
cause a variance between the first set of data and the second set of data to be less than a threshold value by changing one or more of a heat applied to the first one of the waveguides, a voltage applied to a first diode associated with the first one of the waveguides, or a frequency of the voltage applied to the first diode.

17. The photonics system of claim 12 wherein said first and second TOPS are adjacent TOPS.

18. The photonics system of claim 17 wherein the plurality of TOPS are disposed along a plurality of rows and a plurality of columns.

19. The photonics system of claim 18 wherein the plurality of rows are folded.

20. The photonics system of claim 19 further comprising a plurality of Mach-Zehnder Interferometers and a plurality of photodetectors associated with the TOPS.

21. The photonics system of claim 19 wherein an output of each Mach-Zehnder Interferometer is delivered to a different one of the photodetectors, and wherein a signal representative of an output of a first one of the Mach Zehnder interferometers is applied as a feedback signal to a phase shifter associated with the first one of the Mach Zehnder interferometers.

22. The photonics system of claim 19 wherein at least one of the plurality of Mach-Zehnder Interferometers is used to generate the first and second set of data.

23. A photonic integrated circuit comprising:
a plurality of thermo-optic phase shifters arranged along a plurality of columns and a plurality of rows; wherein the plurality of rows are folded;
a plurality of Mach-Zehnder interferometers associated with the plurality of thermo-optic phase shifters; and
a plurality of photodiodes associated with the plurality of thermo-optic phase shifters.

24. The photonic integrated circuit of claim 23 wherein the plurality of thermo-optic phase shifters are configured to receive time-multiplexed modulated voltage waveforms.

25. The photonic integrated circuit of claim 24 wherein the modulated voltage waveforms are selected from pulse-amplitude modulated waveforms and pulse-width modulated waveforms.

26. The photonic integrated circuit of claim 23 wherein a signal representative of an output of a first one the Mach-Zehnder interferometers is fed back to a thermo-optic phase shifter associated with the first one of the Mach-Zehnder interferometers.

27. The photonic integrated circuit of claim 24 wherein a signal associated with at least one of the time-multiplexed modulated voltage waveforms includes pre-emphasis.
